(19) United States
(12) Patent Application Publication
(10) Pub. No.: US 2018/0158373 A1
(43) Pub. Date: Jun. 7, 2018

(54) Wearable Simulant

(71) Applicant: SurgiReal Products, Inc., Loveland, CO (US)

(72) Inventors: Grahm J. Hendrickson, Fort Collins, CO (US); Dean A. Hendrickson, Fort Collins, CO (US)

(73) Assignee: SurgiReal Products, Inc., Loveland, CO (US)

(21) Appl. No.: 15/833,850

(22) Filed: Dec. 6, 2017

Related U.S. Application Data
(60) Provisional application No. 62/430,806, filed on Dec. 6, 2016.

(51) Int. Cl. G09B 23/30; G09B 23/28; G09B 23/36; G09B 9/00

(52) U.S. Cl. CPC G09B 23/30; G09B 9/00; G09B 23/36; G09B 23/285

(57) ABSTRACT

A wearable simulant, and methods of making and using such a wearable simulant, whereby the wearable simulant comprises a flexible simulated body tissue layer; a flexible penetration-resistant layer coupled to the simulated body tissue layer; and an attachment system coupled to the simulated body tissue layer, the attachment system configured to attach said wearable simulant to a wearer to provide a worn simulant.

This United States Non-Provisional Patent Application claims the benefit of U.S. Provisional Patent Application No. 62/430,806, filed Dec. 6, 2016, hereby incorporated by reference herein.

### I. SUMMARY OF THE INVENTION

A broad object of a particular embodiment of the invention can be to provide a wearable simulant, and methods of making and using such a wearable simulant, whereby the wearable simulant comprises a flexible simulated body tissue layer; a flexible penetration-resistant layer coupled to the simulated body tissue layer; and an attachment system coupled to the simulated body tissue layer, the attachment system configured to attach the wearable simulant to a wearer to provide a worn simulant.

Naturally, further objects of the invention are disclosed throughout other areas of the specification, drawings, and claims.

### II. A BRIEF DESCRIPTION OF THE DRAWINGS

FIG. 1A is an illustration of a method of using a particular embodiment of the wearable simulant for practicing a clinical procedure involving puncture by a needle and subsequent withdrawal of simulated physiological fluid from a conduit lumen, whereby the wearable simulant is shown on an animal, and specifically on the limb of a dog.

FIG. 1B is an illustration of a method of using a particular embodiment of the wearable simulant for practicing a clinical procedure involving puncture by a needle and subsequent cannulation, whereby the wearable simulant is shown on a human, and specifically on the hand of a human.

FIG. 1C is an illustration of a method of using a particular embodiment of the wearable simulant for practicing a clinical procedure involving open wound or laceration closure techniques, and specifically suturing.

FIG. 2A is a perspective view of a particular embodiment of the wearable simulant flexed about and conforming to a nonplanar surface, whereby this particular embodiment of the wearable simulant includes a conduit.

FIG. 2B is a perspective view of the particular embodiment of the wearable simulant shown in FIG. 2A, whereby the wearable simulant can be planar or substantially planar when not conforming to a nonplanar surface.

FIG. 2C is a top view of the particular embodiment of the wearable simulant shown in FIG. 2B.

FIG. 2D is a first end view of the particular embodiment of the wearable simulant shown in FIG. 2B.

FIG. 2E is a bottom view of the particular embodiment of the wearable simulant shown in FIG. 2B.

FIG. 2F is a second end view of the particular embodiment of the wearable simulant shown in FIG. 2B.

FIG. 2G is a first side view of the particular embodiment of the wearable simulant shown in FIG. 2B.

FIG. 2H is a second side view of the particular embodiment of the wearable simulant shown in FIG. 2B.

FIG. 3 is a first side view of the particular embodiment of the wearable simulant shown in FIG. 2B, whereby a needle is shown passing through a conduit but being precluded from further passage by a flexible penetration-resistant layer of the wearable simulant.

FIG. 4A is a perspective view of a particular embodiment of the wearable simulant including a wound simulant configured as an open wound or laceration requiring closure.

FIG. 4B is a top view of the particular embodiment of the wearable simulant shown in FIG. 4A.

FIG. 5A is a perspective view of a particular embodiment of a flexible penetration-resistant layer of the wearable simulant, whereby the flexible penetration-resistant layer comprises a plurality of rigid guard plates coupled to a flexible substrate in spaced-apart relation.

FIG. 5B is a top view of the particular embodiment of the flexible penetration-resistant layer shown in FIG. 5A.

FIG. 6A is a perspective view of a particular embodiment of a flexible penetration-resistant layer of the wearable simulant, whereby the flexible penetration-resistant layer comprises a plurality of rigid guard plates coupled to a flexible substrate in spaced-apart relation.

FIG. 6B is a top view of the particular embodiment of the flexible penetration-resistant layer shown in FIG. 6A.

FIG. 7 is a perspective view of a particular embodiment of the wearable simulant including a plurality of flexible simulated body tissue layers.

FIG. 8A is a top view of a particular embodiment of the wearable simulant having a flexible simulated body tissue layer releasably coupled to an attachment system.

FIG. 8B is a first side view of the particular embodiment of the wearable simulant shown in FIG. 8A.

FIG. 8C is a first side view of the particular embodiment of the wearable simulant shown in FIG. 8A, but whereby the flexible simulated body tissue layer is uncoupled from the attachment system.

### III. DETAILED DESCRIPTION OF THE PREFERRED EMBODIMENTS

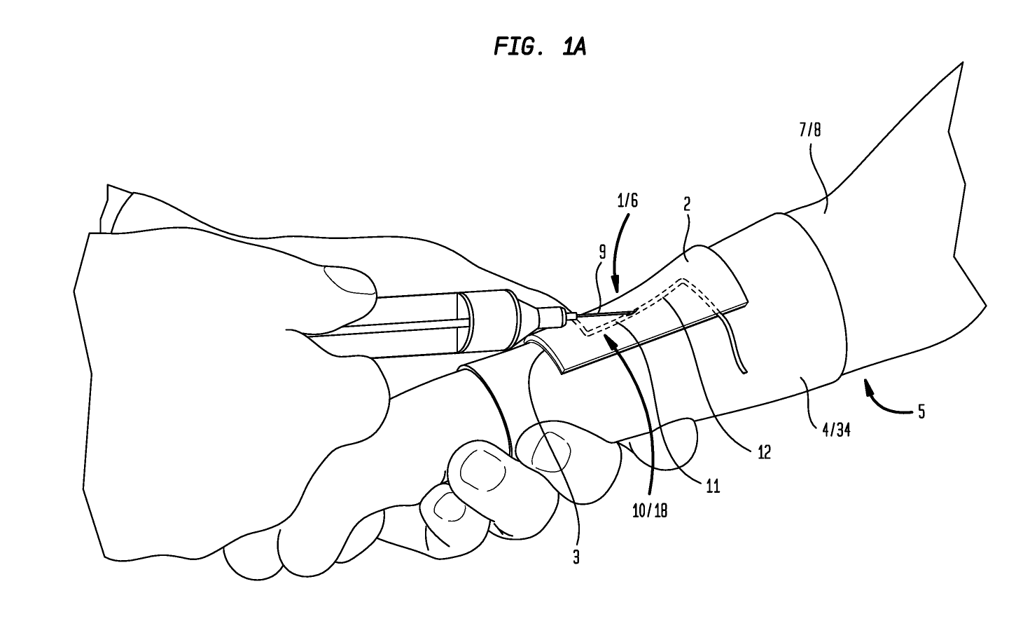

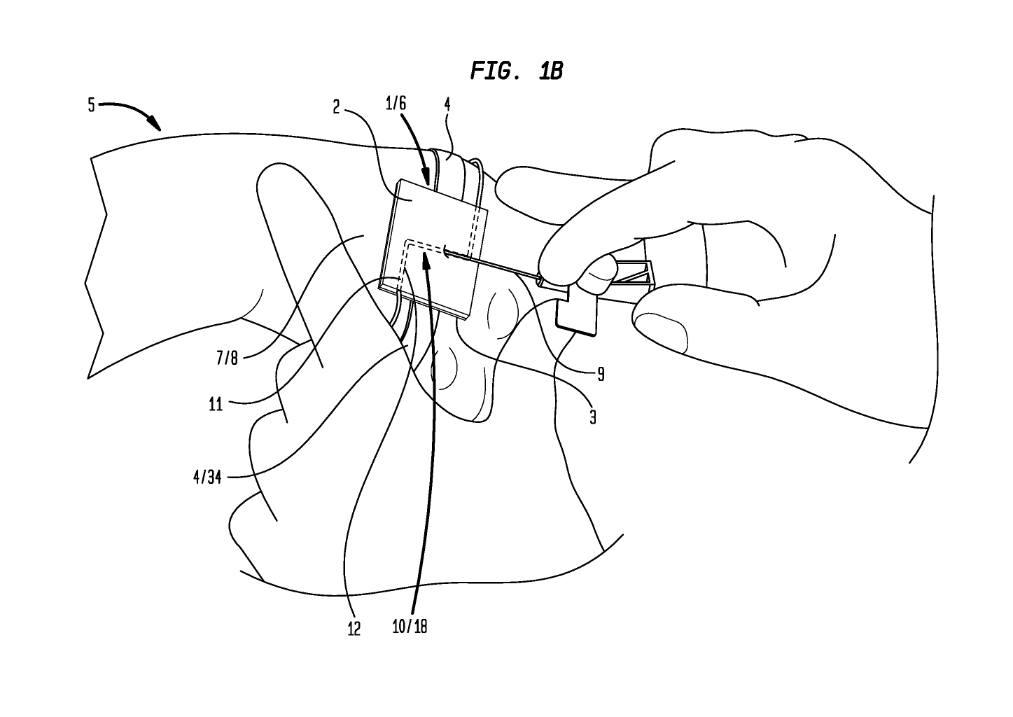

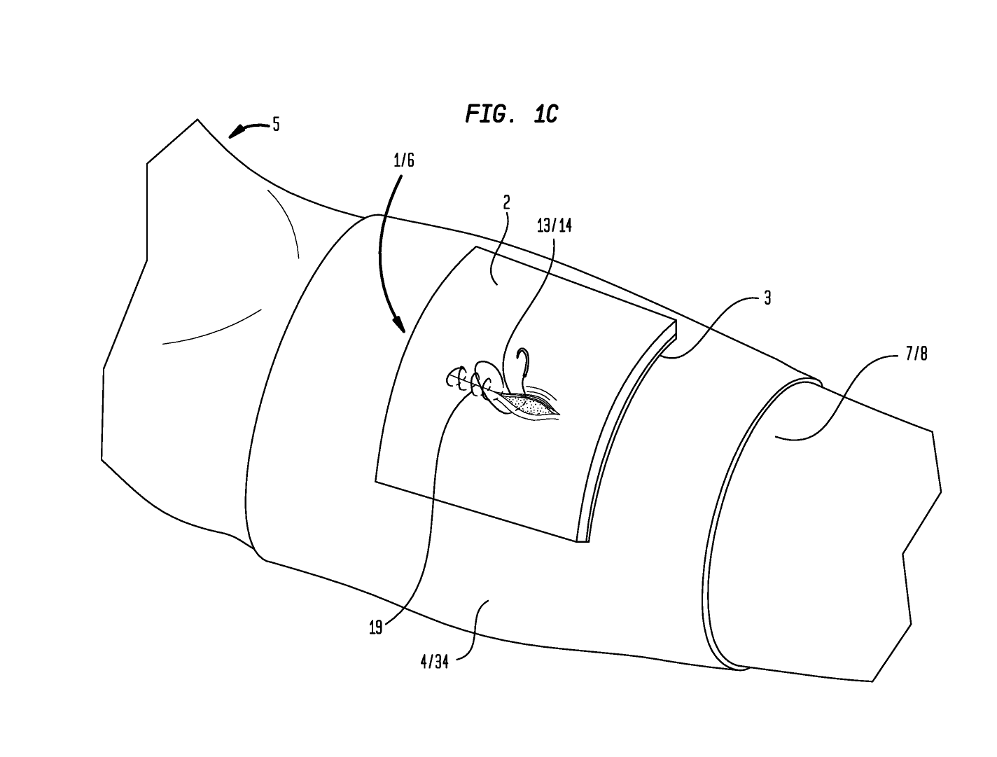

Now referring primarily to FIG. 1A through FIG. 1C, which illustrate methods of using particular embodiments of a wearable simulant (1) to practice clinical procedures, whereby the wearable simulant (1) includes a flexible simulated body tissue layer (2), a flexible penetration-resistant layer (3) coupled to the flexible simulated body tissue layer (2), and an attachment system (4) coupled to the flexible simulated body tissue layer (2), whereby the attachment system (4) can be configured to attach the wearable simulant (1) to a wearer (5) to provide a worn simulant (6).

As used herein, the term “wearable” means capable of being worn on a body portion (7), whereby the instant wearable simulant (1) can be worn on a body portion (7) of a human or an animal, depending upon the application.

As used herein, the term “simulate” and derivatives thereof refer to imitating or mimicking something else.

As used herein, the term “flexible” means capable of being relatively easily flexed or bent. Consequently, a flexible layer, band, strip, strap, or panel can be conformable to a nonplanar surface (8), or can have an amount of flex which allows the flexible layer, band, strip, strap, or panel to conform to a nonplanar surface (8), for example a nonplanar surface (8) of a body portion (7) of a wearer (5) wearing the worn simulant (6). In other words, a flexible layer, band, strip, strap, or panel can be adapted to conformably couple to or engage with a body portion (7) of a wearer (5) wearing the worn simulant (6). Upon conforming to the nonplanar surface (8) of the body portion (7) of the wearer (5) wearing the worn simulant (6), the flexible layer, band, strip, strap, or panel can dispose in parallel or substantially parallel relation to the nonplanar surface (8).

As used herein, the term “penetration-resistant” denotes the ability of a material to resist penetration under normal conditions, for example the ability of a material to resist penetration by a foreign object, such as a sharp object.

Penetration-resistant material can also be puncture-resistant, whereby the material resists being punctured by a sharp object, such as a needle (9) (and particularly, the tip of a needle (9)), a cutting agent like a scalpel or razor blade, or the like.

Again referring primarily to FIG. 1A through FIG. 1C, the method of using the above-described wearable simulant (1) can include attaching the wearable simulant (1) to a wearer (5) via the attachment system (4) to provide the worn simulant (6), and practicing the clinical procedure on the worn simulant (6).

Now referring primarily to FIG. 1A and FIG. 1B, as to particular embodiments, the wearable simulant (1) can further include a conduit (10) disposed above the flexible penetration-resistant layer (3), whereby the conduit (10) can be configured to contain or pass therethrough simulated physiological fluid which can egress from a conduit lumen (11) upon puncture of a conduit wall (12) defining the conduit lumen (11). Correspondingly, this embodiment of the wearable simulant (1) may be useful for practicing a clinical procedure involving puncture by a needle (9) and subsequent injection of fluid into the conduit lumen (11), withdrawal of simulated physiological fluid from the conduit lumen (11) (as shown in FIG. 1A), or cannulation (for example intravenous cannulation as shown in the example of FIG. 1B).

Now referring primarily to FIG. 1C, as to other particular embodiments, the wearable simulant (1) can further include a wound simulant (13) coupled to, contained within, or integrated with the flexible simulated body tissue layer (2), whereby the wound simulant (13) can be configured as an open wound or laceration (14) requiring closure. Accordingly, this embodiment of the wearable simulant (1) may be useful for practicing a clinical procedure involving open wound or laceration (14) closure techniques, such as suturing, stapling, application of adhesive tape(s), application of tissue adhesive(s), or the like.

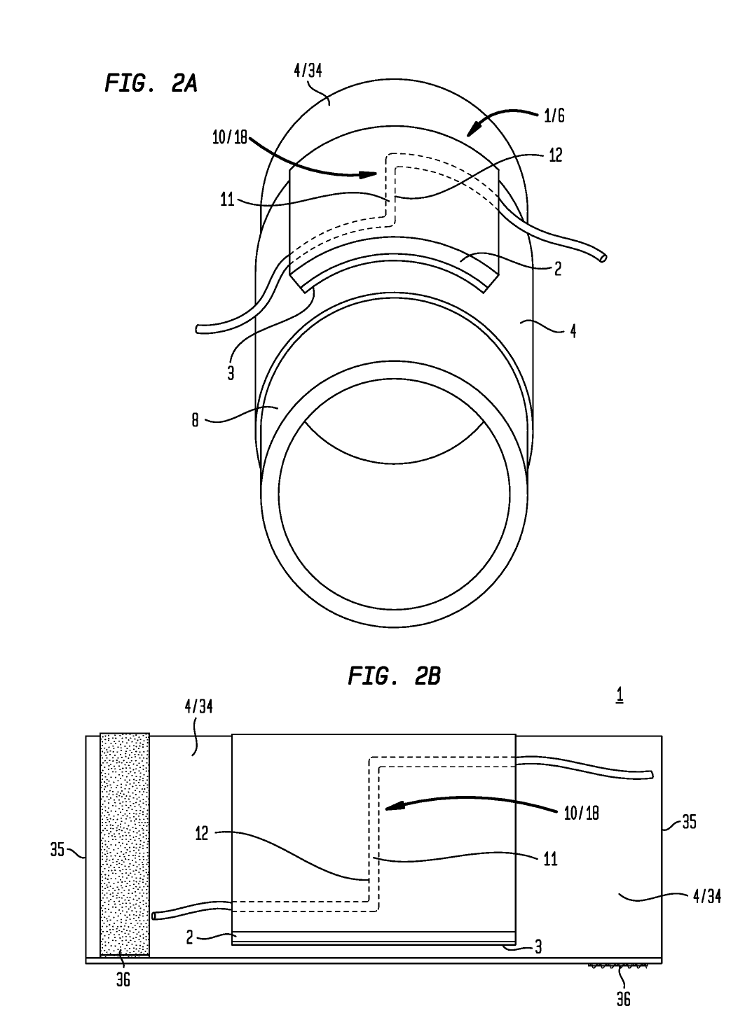

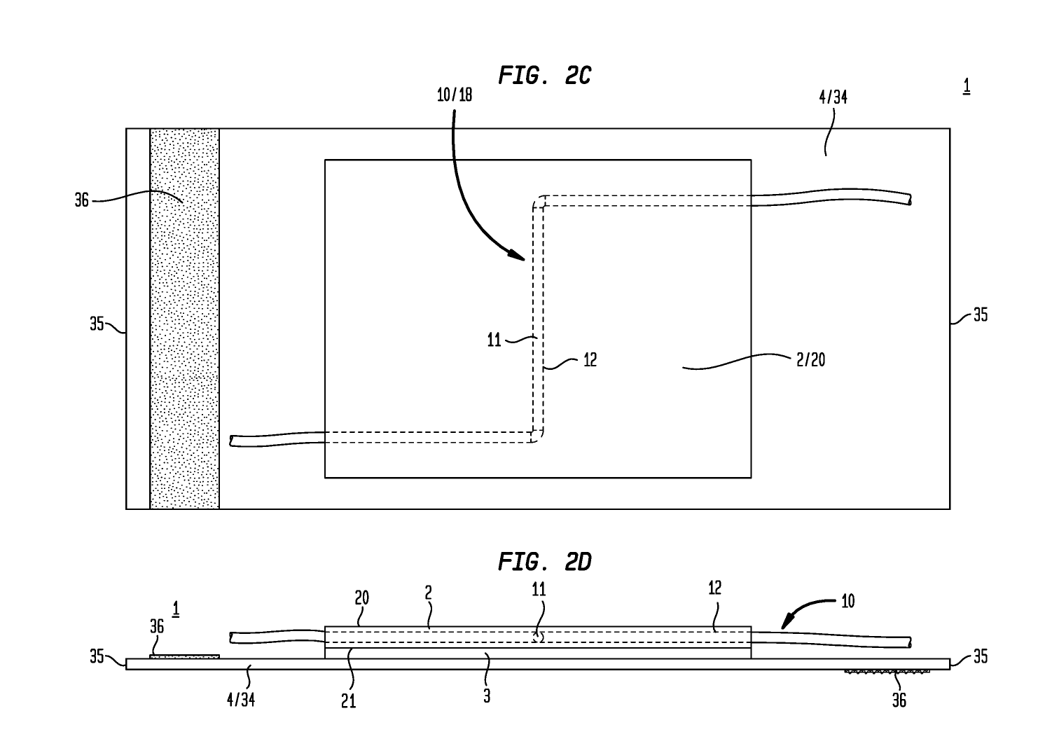

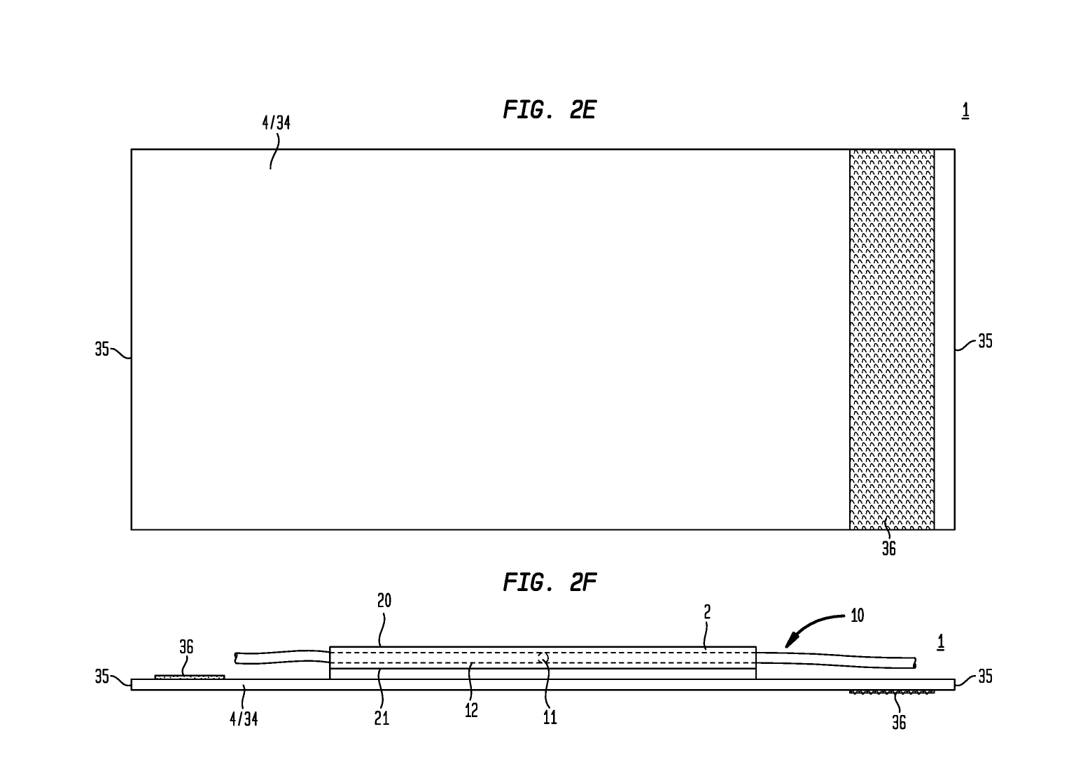

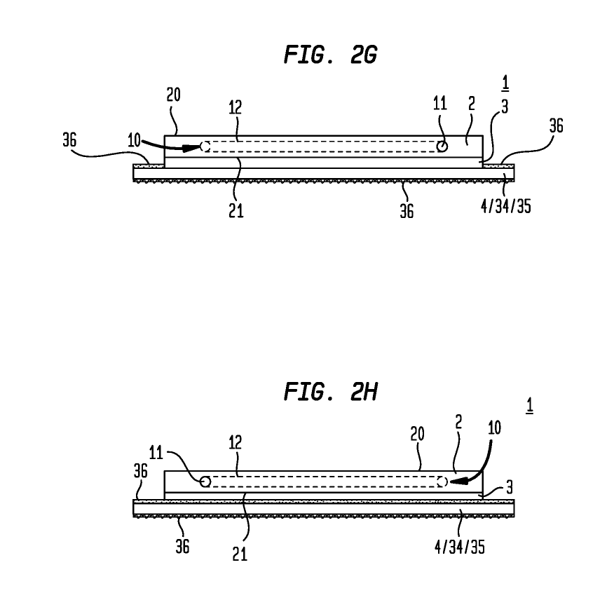

Now referring primarily to FIG. 2A through FIG. 4B, the wearable simulant (1) includes a flexible penetration-resistant layer (3) coupled to at least a portion of the flexible simulated body tissue layer (2), whereby the flexible penetration resistant layer (3) can be coupled to, directly coupled to, connected to, or adjacent the flexible simulated body tissue layer (2), depending upon the embodiment.

Again referring primarily to FIG. 2A through FIG. 4B, the flexible penetration-resistant layer (3) can be coupled to the flexible simulated body tissue layer (2) such that the flexible penetration-resistant layer (3) disposes beneath the flexible simulated body tissue layer (2) when the worn simulant (6) is provided. Said another way, the flexible simulated body tissue layer (2) overlays the flexible penetration-resistant layer (3) when the worn simulant (6) is provided. Following, upon practicing a clinical procedure involving a sharp object, the flexible penetration-resistant layer (3) precludes the sharp object (and particularly, the tip of a sharp object) from contacting and potentially penetrating the skin of the wearer (5) wearing the worm simulant (6).

The flexible penetration-resistant layer (3) is a flexible layer, as described above, meaning that the flexible penetration-resistant layer (3) is capable of being relatively easily flexed or bent and consequently, can conformably couple to or engage with a body portion (7) of a wearer (5) wearing the worn simulant (6).

Of note, the instant flexible penetration-resistant layer (3) is in stark contrast to conventional relatively rigid penetration-resistant materials which are not capable of being relatively easily flexed or bent, for example a plate of standard plastic material which is relatively rigid, such as styrene, acrylic, acrylonitrile butadiene styrene (ABS), polymethylmethacrylate (PMMA), or polycarbonate, or any other relatively rigid material such as ceramic, metal, or wood.

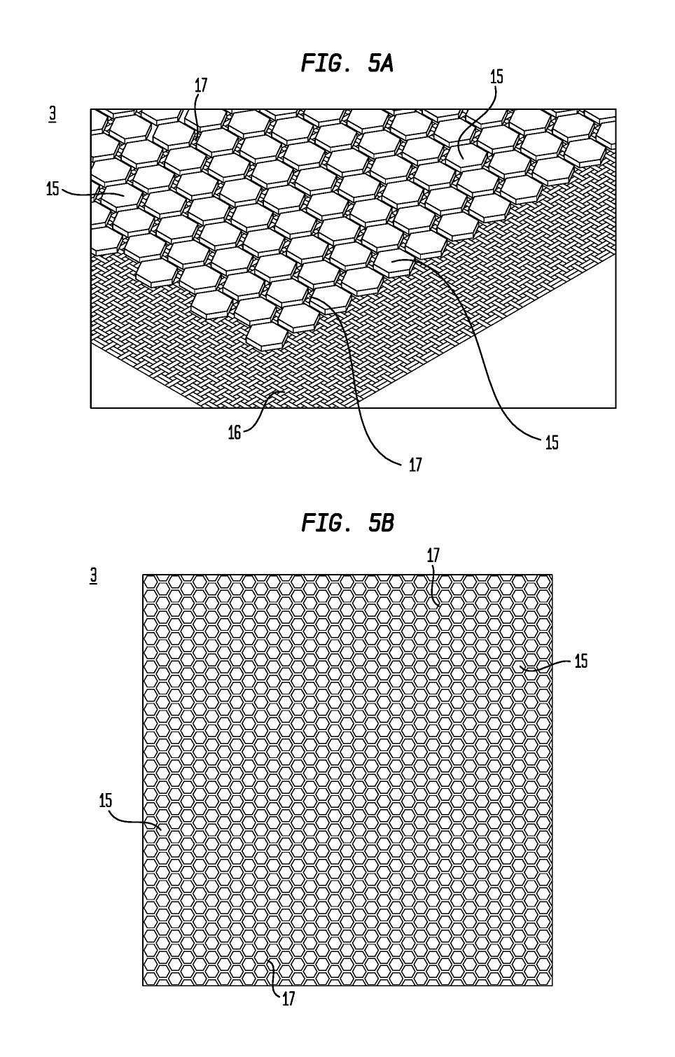

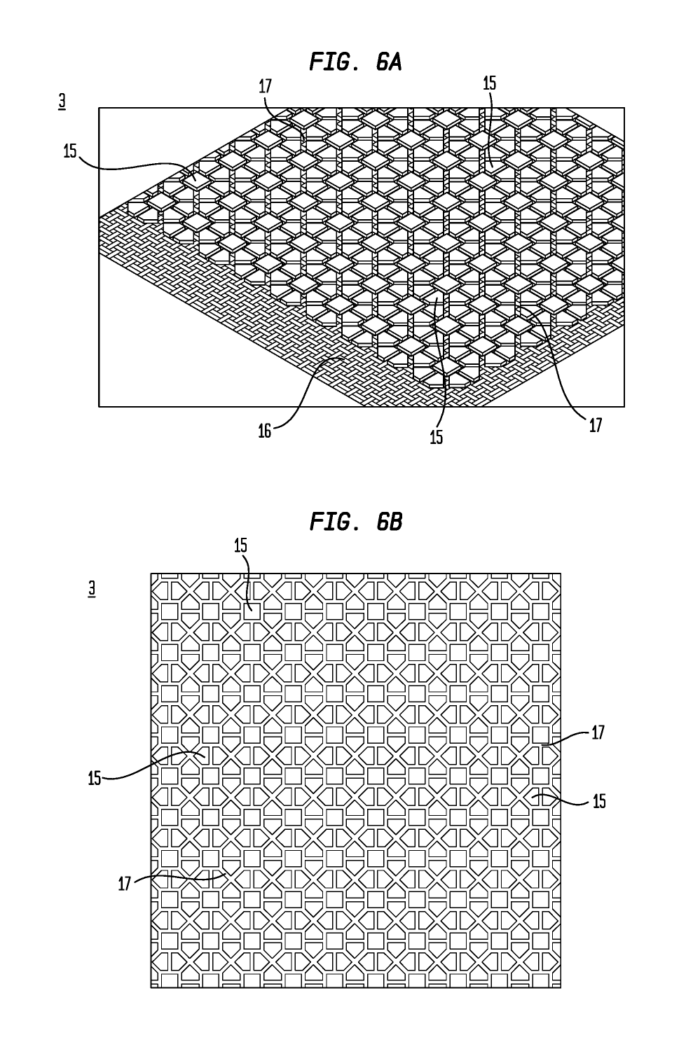

Now referring primarily to FIG. 5A through FIG. 6B, the flexible penetration-resistant layer (3) can be locally solid but globally flexible. As to particular embodiments, the flexible penetration-resistant layer (3) can comprise a plurality of rigid guard plates (15) coupled to a flexible substrate (16) in spaced-apart relation such that the guard plates (15) may be separated from one another by gaps (17). The guard plates (15) provide resistance to penetration and the gaps (17) impart the flexibility of the flexible substrate (16) in areas between the guard plates (15).

As to particular embodiments, the flexible substrate (16) can be fabric, which can be woven or non-woven, depending upon the application.

The guard plates (15), which can have any of a numerous and wide variety of three-dimensional shapes (three of which are illustrated in the non-limiting examples shown in FIG. 5A through FIG. 6B) can be relatively thin and formed from a substance capable of resisting a penetration force equivalent to or stronger than that for which the flexible penetration-resistant layer (3) is intended to resist.

As to particular embodiments, the guard plates (15) can be formed from a polymer resin.

As to particular embodiments, the polymer resin can be printed on the flexible substrate (16) in a design which disposes the guard plates (15) in spaced-apart relation (as illustrated in the non-limiting example shown in FIG. 5A through FIG. 6B). The polymer resin affixes to the flexible substrate (16) during printing and when cured, forms a strong bond therewith.

The composite nature of the flexible penetration-resistant layer (3) makes it possible to realize locally (in an area comprising one or a few guard plates (15)) rigid, penetration-resistant guard plate (15) features. However, at the same time, the overall flexible penetration-resistant layer (3) exhibits global conformability due to the flexibility of the flexible substrate (16) and the spaced-apart relationship of the guard plates (15) which provides the gaps (17).

The instant flexible penetration-resistant layer (3) may be advantageous over traditional ballistic-resistant fabrics formed from aramid fibers (such as KEVLAR®), ultra-high molecular weight polyethylene (UHMWPE), or the like, which typically have a tightly-woven construction in order to achieve their desired protective performance.

Despite their high tensile strength, a single layer of these tightly-woven fabrics is usually ineffective in precluding penetration by sharp objects, such as needles (9) or cutting agents. Following, a plurality of layers of these tightly-woven fabrics are generally required to achieve their desired protective performance.

Conversely, a single layer or only a few layers of the instant flexible penetration-resistant layer (3) are required to achieve effective penetration-resistance for the present application and specifically, for precluding a sharp object from contacting and potentially penetrating the skin of a wearer (5) wearing the worm simulant (6). As to particular embodiments, the wearable simulant (1) can include a number of flexible penetration-resistant layers (3) selected from the group including or consisting of: not greater than 10 layers; not greater than 9 layers; not greater than 8 layers; not greater than 7 layers; not greater than 6 layers; not greater than 5 layers; not greater than 4 layers; not greater than 3 layers; not greater than 2 layers; and not greater than 1 layer.

Additionally, a significant drawback of single or multiple layers of the above-mentioned tightly-woven fabrics may be low air permeability or breathability, which can cause discomfort to a wearer (5), for example because perspiration cannot escape via evaporation. Advantageously, the instant flexible penetration-resistant layer (3) has greater breathability relative to the above-mentioned tightly-woven fabrics due to the gaps (17) between the guard plates (15) as well as the guard plates (15) themselves, which allow material with a substantially looser weave to be utilized as a flexible substrate (16), thus increasing air permeability.

As to particular embodiments, the flexible penetration-resistant layer (3) can comprise SUPERFABRIC®, commercially available from HDM, Inc. in Oakdale, Minn., USA.

As to particular embodiments, the flexible penetration-resistant layer (3) can comprise material or fabric as described in US 2004/0192133, US 2005/0009429, US 2005/0170221, US 2008/0282455, US 2009/0142535, US 2013/0209735, U.S. Pat. No. 6,962,739, U.S. Pat. No. 7,018,692, U.S. Pat. No. 7,504,145, each of which is hereby incorporated by reference in its entirety herein.

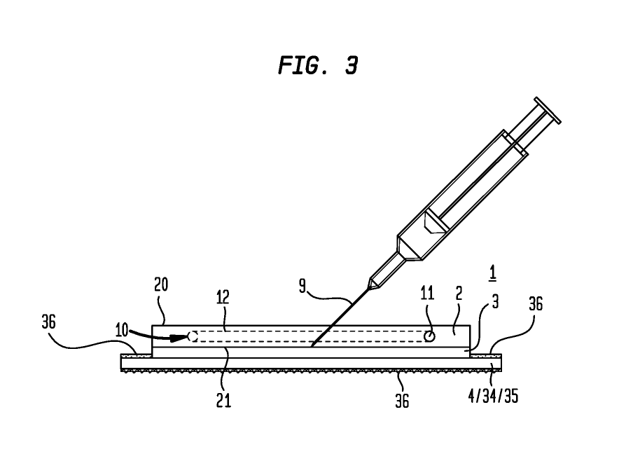

Now referring primarily to FIG. 2A through FIG. 3, the wearable simulant (1) can further include an injectable site (18) disposed above the flexible penetration-resistant layer (3), whereby the injectable site (18) can be configured to receive an injection. Correspondingly, this embodiment of the wearable simulant (1) may be useful for practicing a clinical procedure involving injecting, which may include puncture by a needle (9) and subsequent injection of fluid into the injectable site (18).

As a first non-limiting example, the injectable site (18) can be configured to mimic subcutaneous tissue; following, this embodiment of the wearable simulant (1) may be useful for practicing subcutaneous injections or SubQ injections.

As a second non-limiting example, the injectable site (18) can be configured to mimic muscle tissue; following, this embodiment of the wearable simulant (1) may be useful for practicing intramuscular injections or IM injections.

As to particular embodiments, the injectable site (18) can include an injectable cavity configured to receive and contain fluid from an injection. As to particular embodiments, an absorbent material, such as sponge or foam pad, can be disposed within the injectable cavity to absorb and contain fluid from an injection.

As to particular embodiments, the absorbent material can be insertable and removable.

As to particular embodiments, the absorbent material can be reusable.

Now referring primarily to FIG. 1A, FIG. 1B, and FIG. 2A through FIG. 3, as to particular embodiments, the injectable site (18) can include a conduit (10) disposed above the flexible penetration-resistant layer (3), as described above. To reiterate, the conduit (10) can be configured to contain or pass therethrough at least one simulated physiological fluid which can egress from a conduit lumen (11) upon puncture of a conduit wall (12) defining the conduit lumen (11). Correspondingly, this embodiment of the wearable simulant (1) may be useful for practicing a clinical procedure involving puncture by a needle (9) and subsequent injection of fluid into the conduit lumen (11), withdrawal of simulated physiological fluid from the conduit lumen (11) (as shown in FIG. 1A), or cannulation (for example intravenous cannulation as shown in the example of FIG. 1B).

As to particular embodiments, the conduit (10) can be coupled to a reservoir containing simulated physiological fluid.

As to particular embodiments, the conduit (10) can be configured as simulated vasculature, such as one or more simulated blood vessels which may contain simulated blood. The simulated blood vessel(s) may be useful for practicing a venipuncture procedure, such as intravenous injection, withdrawal of simulated blood, or cannulation.

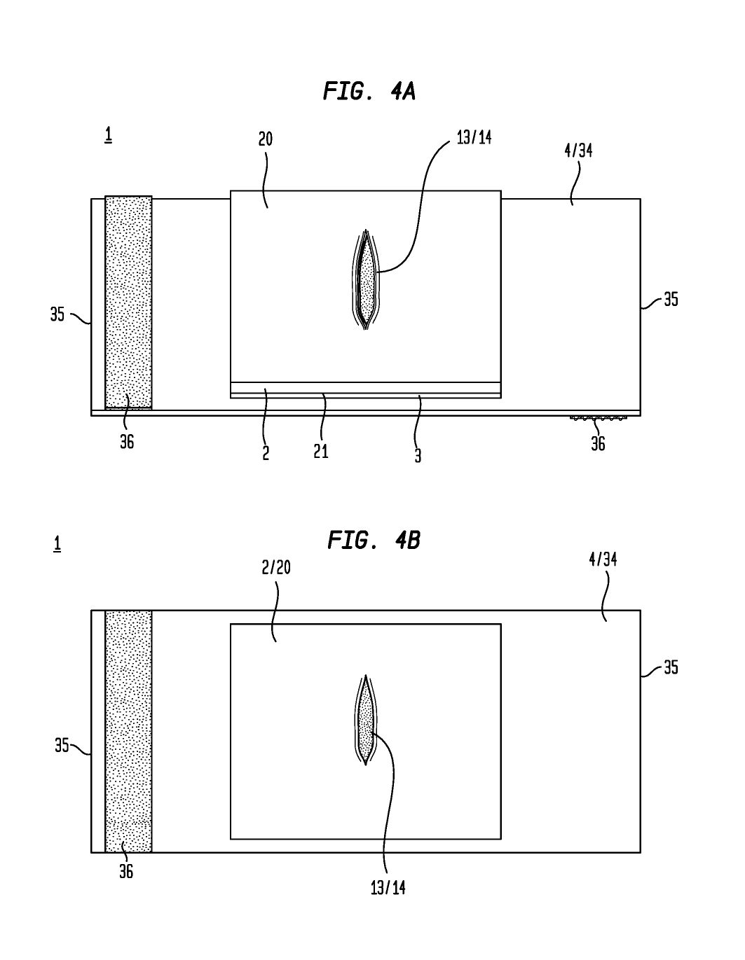

Now referring primarily to FIG. 4A and FIG. 4B, as to particular embodiments, the wearable simulant (1) can further include a wound simulant (13) coupled to, contained within, or integrated with the flexible simulated body tissue layer (2), as described above. To reiterate, the wound simulant (13) can be configured as an open wound or laceration (14) requiring closure. Accordingly, this embodiment of the wearable simulant (1) may be useful for practicing a clinical procedure involving open wound or laceration (14) closure techniques, such as suturing, stapling, application of adhesive tapes, application of tissue adhesives, or the like.

As but one illustrative example, the open wound or laceration (14) can be closed by suturing the surrounding flexible simulated body tissue layer (2) with sutures (19).

As to particular embodiments, the wearable simulant (1) can further include a simulated pathology comprising flowable simulated pathological fluid.

The term “pathology” for the purposes of the present invention means a deviation from a normal condition. As to particular embodiments, the deviation may be associated with one or more diseases.

The term “flowable” for the purposes of the present invention means capable of flowing at room temperature; not solid.

As to particular embodiments, the simulated pathology can be an excisable simulated pathology configured to mimic a cyst, whereby the entirety or substantially the entirety of the excisable simulated pathology can be excised from within a closed cavity interior space as an intact one-piece construct which remains undamaged or substantially undamaged (for example, not ruptured) following the excision. Accordingly, the wearable simulant (1) including the excisable simulated pathology may be useful for honing excision skills.

As to other particular embodiments, the simulated pathology can be a drainable simulated pathology configured to mimic an abscess, whereby the drainable simulated pathology or contents included in the drainable simulated pathology can be drained from within a closed cavity interior space. Accordingly, the wearable simulant (1) including the drainable simulated pathology may be useful for honing drainage skills.

Further details regarding the instant simulated pathology comprising flowable simulated pathological fluid can be found in U.S. Ser. No. 15/299,693, which is hereby incorporated by reference in its entirety herein.

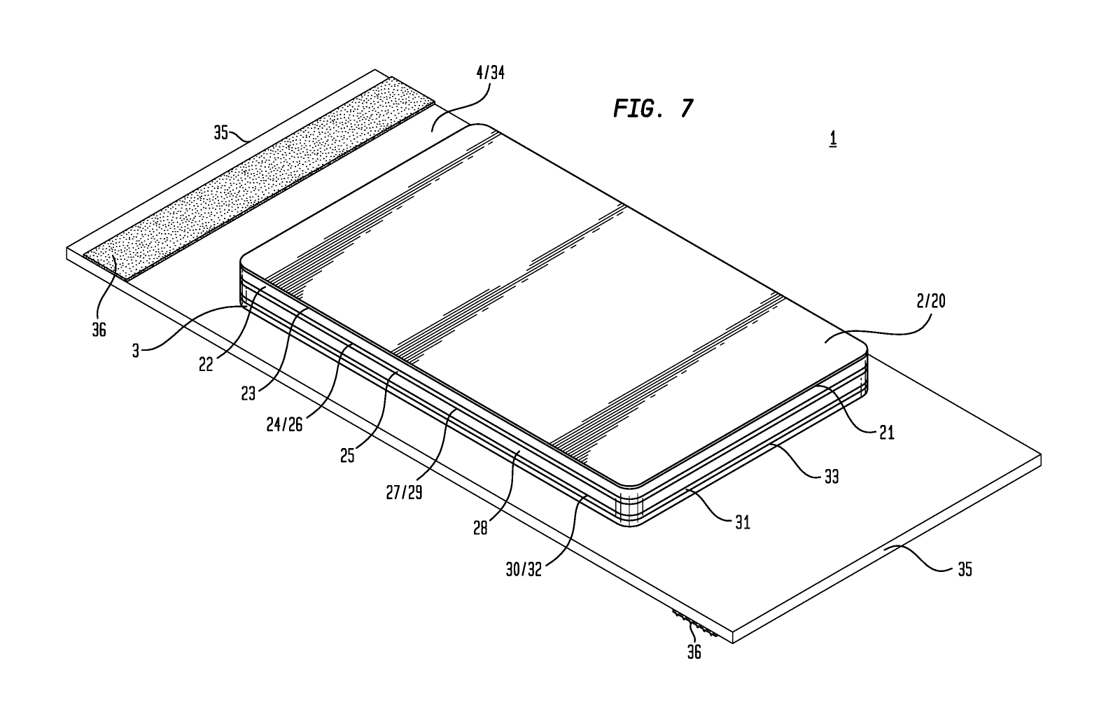

Now referring primarily to FIG. 7, the wearable simulant (1) includes a flexible simulated body tissue layer (2) (also herein referred to as a first flexible simulated body tissue layer (2)) disposed above the flexible penetration-resistant layer (3), whereby the first flexible simulated body tissue layer (2), as well as other flexible simulated body tissue layers, can mimic real body tissue in both appearance and physical characteristics. As to particular embodiments, the first flexible simulated body tissue layer (2) can be configured to mimic skin or an epidermis-dermis layer.

Typically in animals (including humans), a real epidermis is comprised of the outermost layers of cells in the skin, whereby the epidermis can be a stratified squamous epithelium including proliferating basal and differentiated suprabasal keratinocytes which provide a barrier against the environment. The epidermis overlays the dermis, which comprises connective tissue.

Following, as to particular embodiments, the first flexible simulated body tissue layer (2) which mimics an epidermis-dermis layer can be resistant to tearing, able to hold a suture, and have limited elasticity. Moreover, as to particular embodiments, the first flexible simulated body tissue layer (2) which mimics an epidermis-dermis layer can have a texture, thickness, durometer, color, and surface details that closely simulate a real epidermis and dermis.

In contrast to the flexible penetration-resistant layer (3), the first flexible simulated body tissue layer (2) can be penetrable, meaning that the first flexible simulated body tissue layer (2) can be penetrated under normal conditions by a foreign object, such as a sharp object like a needle (9). Correspondingly, the sharp object can pass through the first flexible simulated body tissue layer (2), either partially or entirely, until contacting the flexible penetration-resistant layer (3), which precludes penetration by the sharp object.

Again referring primarily to FIG. 7, the first flexible simulated body tissue layer (2) includes opposing first flexible simulated body tissue layer upper and lower faces (20)(21), whereby the first flexible simulated body tissue layer lower face (21) couples to or overlays the flexible penetration-resistant layer (3) when the worn simulant (6) is provided.

When not being worn by a wearer (5) and consequently, when not conforming to a nonplanar surface (8) of a body portion (7) of a wearer (5), the first flexible simulated body tissue layer upper and lower faces (20) (21) can be planar or substantially planar, meaning flat or substantially flat.

Again referring primarily to FIG. 7, in addition to the first flexible simulated body tissue layer (2), the wearable simulant (1) can, but need not necessarily, further include one or more additional layers, each of which may also be a flexible layer but, when not conforming to a nonplanar surface (8) of a body portion (7) of a wearer (5), may have planar or substantially planar opposing upper and lower faces.

As to particular embodiments, the wearable simulant (1) can further include a second flexible simulated body tissue layer (22) having opposing second flexible simulated body tissue layer upper and lower faces (23) (24), whereby the second flexible simulated body tissue layer (22) can be coupled to the first flexible simulated body tissue layer (2) such that the second flexible simulated body tissue layer upper face (23) engages with the first flexible simulated body tissue layer lower face (21).

As to this particular embodiment, the second flexible simulated body tissue layer (22) can be configured to mimic a hypodermis or subcutaneous tissue layer.

Typically in animals (including humans), a real subcutaneous tissue layer primarily comprises adipose tissue and a lesser amount of connective tissue. Accordingly, the second flexible simulated body tissue layer (22) can be configured to generally simulate adipose tissue, whereby characteristics of the second flexible simulated body tissue layer (22), such as thickness, durometer, and color, can be adapted as needed, depending upon the application.

As to particular embodiments, the second flexible simulated body tissue layer (22) can have a lesser resistance to strain in comparison to the first flexible simulated body tissue layer (2). In addition, as to particular embodiments, the second flexible simulated body tissue layer (22) can have greasy, soft, and compliant tactile characteristics or the tactile characteristics of harder, denser fat tissue.

Again referring primarily to FIG. 7, the wearable simulant (1) can, but need not necessarily, further include a third flexible simulated body tissue layer (25) having opposing third flexible simulated body tissue layer upper and lower faces (26) (27), whereby the third flexible simulated body tissue layer (25) can be coupled to the second flexible simulated body tissue layer (22) such that the third flexible simulated body tissue layer upper face (26) engages with the second flexible simulated body tissue layer lower face (24).

As to this particular embodiment, the third flexible simulated body tissue layer (25) can be configured to mimic a first layer of fascia, whereby real fascia comprises a band or sheet of connective tissue fibers beneath the skin which attach, stabilize, enclose, and separate muscles and other internal organs.

Again referring primarily to FIG. 7, the wearable simulant (1) can, but need not necessarily, further include a fourth flexible simulated body tissue layer (28) having opposing fourth flexible simulated body tissue layer upper and lower faces (29) (30), whereby the fourth flexible simulated body tissue layer (28) can be coupled to the third flexible simulated body tissue layer (25) such that the fourth flexible simulated body tissue layer upper face (29) engages with the third flexible simulated body tissue layer lower face (27). As to this particular embodiment, the fourth flexible simulated body tissue layer (28) can be configured to mimic muscle tissue which can, but need not necessarily, be colored red.

Again referring primarily to FIG. 7, the wearable simulant (1) can, but need not necessarily, further include a fifth flexible simulated body tissue layer (31) having opposing fifth flexible simulated body tissue layer upper and lower faces (32) (33), whereby the fifth flexible simulated body tissue layer (31) can be coupled to the fourth flexible simulated body tissue layer (28) such that the fifth flexible simulated body tissue layer upper face (32) engages with the fourth flexible simulated body tissue layer lower face (30). As to this particular embodiment, the fifth flexible simulated body tissue layer (31) can be configured to mimic a second layer of fascia, as described above for the first layer of fascia.

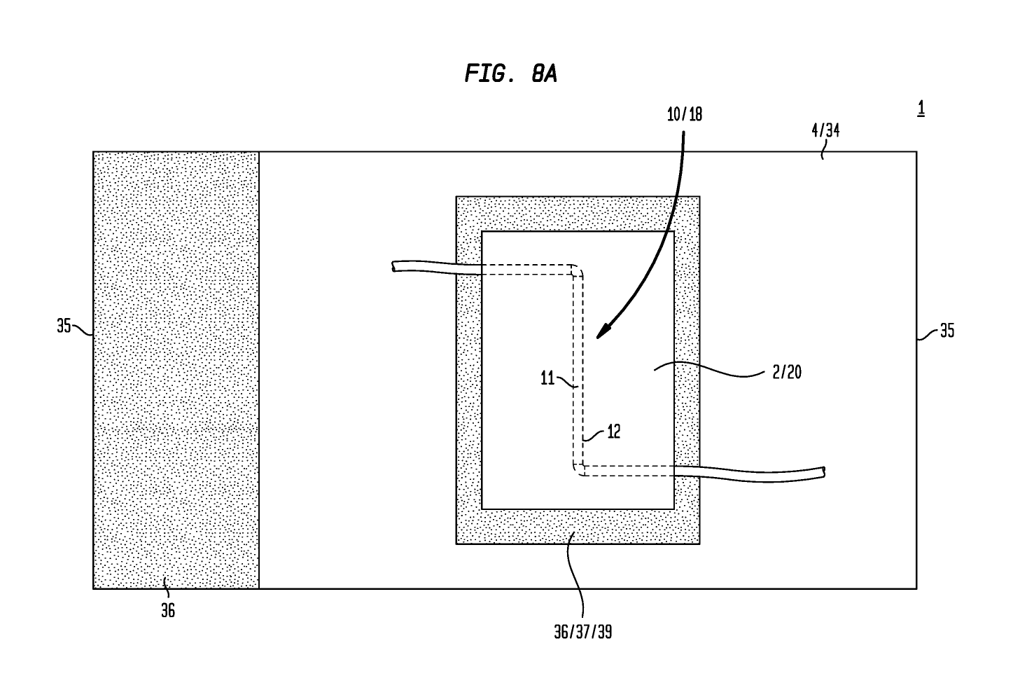

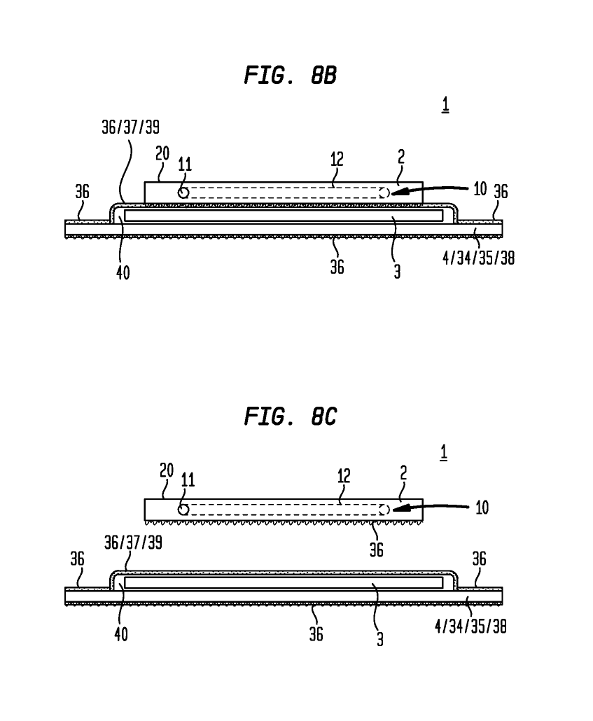

Now referring primarily to FIG. 2A through FIG. 4B, and FIG. 7 through FIG. 8C, the wearable simulant (1) further includes an attachment system (4) coupled to the flexible simulated body tissue layer (2), whereby the attachment system (4) can be configured to attach the wearable simulant (1) to a wearer (5) to provide a worn simulant (6).

As to particular embodiments, the attachment system (4) can be configured to dispose about a body portion (7) of a wearer (5). For example, the attachment system (4) can be configured as flexible elongate member (34), such as a band, strip, strap, panel, or the like, which can be disposed about or wrapped around a body portion (7) of a wearer (5) to attach the wearable simulant (1) to the wearer (5) to provide a worn simulant (6).

As to particular embodiments, the flexible elongate member (34) can be a continuous annular member formed from a resiliently stretchable material. Following, the continuous annular member can have a relatively smaller circumference when in an unstretched condition, and can be stretched or expanded to have a relatively larger circumference for disposition about a body portion (7) of a wearer (5). Once positioned about the body portion (7), the continuous annular member can contract to engagingly fit about the body portion (7), thereby securely attaching the wearable simulant (1) to the wearer (5).

As to other particular embodiments, the flexible elongate member (34) can terminate in opposing ends (35) which can releasably couple or removably couple to one another, for example once the flexible elongate member (34) is positioned about a body portion (7) of a wearer (5) to securely attach the wearable simulant (1) to the wearer (5).

As to particular embodiments, the flexible elongate member (34) can have an adjustable length. Subsequently, the opposing ends (35) can be configured to releasably couple or removably couple to one another at more than one coupling point along the length of the flexible elongate member (34) to provide the adjustable length. For example, to achieve a lesser length upon coupling, the opposing ends (35) can be coupled together such that there is a relatively greater distance between the coupling point and at least one of the opposing ends (35). Correspondingly, to achieve a greater length upon coupling, the opposing ends (35) can be coupled together such that there is a relatively lesser distance between the coupling point and at least one of the opposing ends (35).

Again referring primarily to FIG. 2A through FIG. 4B, and FIG. 7 through FIG. 8C, as to particular embodiments, at least one of the opposing ends (35) can include a fastening element (36) configured to releasably couple or removably couple the opposing ends (35) to one another, whereby as illustrative examples, the fastening element (36) may include one or more adhesive fasteners (such as releasable adhesive fasteners), mechanical fasteners, or the like, or combinations thereof.

As non-limiting examples, mechanical fasteners can include: matable hook and loop fastening elements, buckles, buttons, clamps, clips, grommets, hook-and-eye closures, pins, rivets, snap fasteners, staples, stitches, ties, zippers, or the like, or combinations thereof.

As to the particular embodiments shown in the Figures, the attachment system (4) can include a flexible elongate member (34) having an adjustable length and opposing ends (35), one of which includes a hook fastening element and the other of which includes a loop fastening element. Accordingly, once the flexible elongate member (34) is positioned about a body portion (7) of a wearer (5), the hook and loop fastening elements can be matably engaged to securely attach the wearable simulant (1) to the wearer (5).

As to particular embodiments, the attachment system (4) can be fixedly or permanently coupled to the flexible simulated body tissue layer (2), meaning affixed or joined so as to work together as a single complete piece or unit, and so as to be incapable of being easily dismantled without destroying the integrity of the piece or unit.

Now referring primarily to FIG. 8A through FIG. 8C, as to other particular embodiments, the attachment system (4) can be releasably coupled or removably coupled to the flexible simulated body tissue layer (2), meaning (i) not permanently affixed or (ii) coupled or couplable such that the elements tend to remain coupled absent a separation force applied to one or both of the elements, and the elements being capable of separation without substantial permanent deformation or rupture, whereby the required separation force is typically beyond that encountered while wearing the worn simulant (6).

As to particular embodiments, at least one of the attachment system (4), the flexible simulated body tissue layer (2), or the flexible penetration-resistant layer (3) can include a fastening element (36) configured to releasably couple or removably couple the attachment system (4) to the flexible simulated body tissue layer (2), whereby as illustrative examples, the fastening element (36) may include one or more adhesive fasteners (such as releasable adhesive fasteners), mechanical fasteners, or the like, or combinations thereof.

As non-limiting examples, mechanical fasteners can include: matable hook and loop fastening elements, buckles, buttons, clamps, clips, grommets, hook-and-eye closures, pins, rivets, snap fasteners, staples, stitches, ties, zippers, or the like, or combinations thereof.

As to particular embodiments, one of a hook fastening element or a loop fastening element can be coupled to the attachment system (4) and the other hook fastening element or loop fastening element can be coupled to the flexible simulated body tissue layer (2). Following, upon matable engagement of the hook and loop fastening elements, the attachment system (4) can be securely attached to the flexible simulated body tissue layer (2).

Now referring primarily to FIG. 2A through FIG. 2H, as to particular embodiments, the flexible penetration-resistant layer (3) can be fixedly or permanently coupled to the flexible simulated body tissue layer (2) to provide a discrete combined flexible simulated body tissue layer (2) and flexible penetration-resistant layer (3), whereby the flexible simulated body tissue layer (2) and the flexible penetration-resistant layer (3) can be affixed or joined so as to work together as a single complete piece or unit, and so as to be incapable of being easily dismantled without destroying the integrity of the piece or unit. As to this particular embodiment which may further include an attachment system (4) releasably coupled or removably coupled to the combined flexible simulated body tissue layer (2) and flexible penetration-resistant layer (3), one of the hook fastening elements or loop fastening elements can be coupled to the attachment system (4) and the other hook fastening element or loop fastening element can be coupled to the combined flexible simulated body tissue layer (2) and flexible penetration-resistant layer (3) beneath the flexible penetration-resistant layer (3). Following, upon matable engagement of the hook and loop fastening elements, the attachment system (4) can be securely attached to the combined flexible simulated body tissue layer (2) and flexible penetration-resistant layer (3).

Now referring primarily to FIG. 8A through FIG. 8C, as to other particular embodiments, the flexible penetration-resistant layer (3) can be coupled to the attachment system (4) to provide a discrete combined attachment system (4) and flexible penetration-resistant layer (3). As to this particular embodiment which may further include a flexible simulated body tissue layer (2) releasably coupled or removably coupled to the combined attachment system (4) and flexible penetration-resistant layer (3), one of a hook fastening element or a loop fastening element can be coupled to the combined attachment system (4) and flexible penetration-resistant layer (3) and the other hook fastening element or loop fastening element can be coupled to the flexible simulated body tissue layer (2). Following, upon matable engagement of the hook and loop fastening elements, the flexible simulated body tissue layer (2) can be securely attached to the combined attachment system (4) and flexible penetration-resistant layer (3).

Again referring primarily to FIG. 8A through FIG. 8C, as to particular embodiments, the flexible penetration-resistant layer (3) can be coupled to the attachment system (4) by means of a receptacle (37) coupled to or integrated with the attachment system (4).

As to particular embodiments, the receptacle (37) can be coupled to or integrated with the flexible elongate member (34). For example, the flexible elongate member (34) can provide a receptacle rear panel (38) to which a receptacle front panel (39) can be coupled to define a receptacle interior space (40) therebetween, whereby the receptacle interior space (40) can be configured to removably receive and contain the flexible penetration-resistant layer (3). In this way, the flexible penetration-resistant layer (3) can be removably coupled to the attachment system (4) to provide a combined attachment system (4) and flexible penetration-resistant layer (3). Further, the flexible simulated body tissue layer (2) can be releasably coupled or removably coupled to the combined attachment system (4) and flexible penetration-resistant layer (3) to provide the wearable simulant (1).

As to particular embodiments having one of a hook fastening element or a loop fastening element coupled to the attachment system (4) and the other hook fastening element or loop fastening element coupled to the flexible simulated body tissue layer (2), the hook fastening element or loop fastening element coupled to the attachment system (4) can provide the receptacle front panel (39).

Now regarding production, a method of making a particular embodiment of the instant wearable simulant (1) can include: coupling a flexible penetration-resistant layer (3) to a flexible simulated body tissue layer (2), and coupling an attachment system (4) to the flexible simulated body tissue layer (2), whereby the attachment system (4) can be configured to attach the wearable simulant (1) to a wearer (5) to provide a worn simulant (6).

The method of making the wearable simulant (1) can further include providing additional components of the wearable simulant (1) as described above and in the claims.

As to particular embodiments, the method can, but need not necessarily, further include using a mold to generate the wearable simulant (1), whereby the mold includes a mold interior lower surface configured to mimic a negative of a surface of a body tissue which the wearable simulant (1) is intended to simulate.

Further details regarding using a mold to generate the wearable simulant (1) can be found in U.S. Ser. No. 15/299,693, which is hereby incorporated by reference in its entirety herein.

As to particular embodiments, each of the first, second, third, fourth, and fifth flexible simulated body tissue layers (2) (22) (25) (28) (31) can be substantially formed of a silicone rubber and can mimic real body tissue in both appearance and physical characteristics.

As to particular embodiments, each of the first, second, third, fourth, and fifth flexible simulated body tissue layers (2) (22) (25) (28) (31) can be substantially formed as described in U.S. Pat. No. 8,915,742, which is hereby incorporated by reference in its entirety herein.

As can be easily understood from the foregoing, the basic concepts of the present invention may be embodied in a variety of ways. The invention involves numerous and varied embodiments of a wearable simulant and methods for making and using such a wearable simulant.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “layer” should be understood to encompass disclosure of the act of “layering”—whether explicitly discussed or not—and, conversely, were there effectively disclosure of the act of “layering”, such a disclosure should be understood to encompass disclosure of a “layer” and even a “means for layering”. Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Further, for the purposes of the present invention, the term “coupled” or derivatives thereof can mean indirectly coupled, coupled, directly coupled, connected, directly connected, or integrated with, depending upon the embodiment.

Thus, the applicant(s) should be understood to claim at least: i) each of the wearable simulants herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A wearable simulant comprising:
a flexible simulated body tissue layer;
a flexible penetration-resistant layer coupled to said flexible simulated body tissue layer; and
an attachment system coupled to said flexible simulated body tissue layer, said attachment system configured to attach said wearable simulant to a wearer to provide a worn simulant.

2-5. (canceled)

6. The wearable simulant of claim 1, wherein said flexible penetration-resistant layer disposes beneath said flexible simulated body tissue layer.

7. The wearable simulant of claim 1, wherein said flexible penetration-resistant layer is locally solid and globally flexible.

8. The wearable simulant of claim 7, wherein said flexible penetration-resistant layer comprises a plurality of rigid guard plates coupled to a flexible substrate in spaced-apart relation.

9. The wearable simulant of claim 8, wherein said flexible substrate comprises fabric.

10. The wearable simulant of claim 8, wherein said guard plates comprise polymer resin.

11. The wearable simulant of claim 10, wherein said guard plates are printed on said flexible substrate.

12-17. (canceled)

18. The wearable simulant of claim 1, further comprising a conduit disposed above said flexible penetration-resistant layer.

19. The wearable simulant of claim 18, wherein said conduit disposes beneath said flexible simulated body tissue layer.

20-37. (canceled)

38. The wearable simulant of claim 1, wherein said attachment system comprises a flexible elongate member.

39. (canceled)

40. The wearable simulant of claim 38, wherein said flexible elongate member terminates in opposing ends configured to releasably couple to one another.

41. The wearable simulant of claim 40, wherein said flexible elongate member comprises an adjustable length.

42. (canceled)

43. The wearable simulant of claim 40, wherein at least one of said opposing ends comprises a fastening element.

44. The wearable simulant of claim 43, wherein said fastening element comprises matable hook and loop fastening elements.

45. The wearable simulant of claim 1, wherein said attachment system is fixedly coupled to said flexible simulated body tissue layer.

46. The wearable simulant of claim 1, wherein said attachment system is releasably coupled to said flexible simulated body tissue layer.

47-49. (canceled)

50. The wearable simulant of claim 1, wherein said flexible penetration-resistant layer is fixedly coupled to said flexible simulated body tissue layer.

51. The wearable simulant of claim 1, wherein said flexible penetration-resistant layer is coupled to said attachment system.

52. The wearable simulant of claim 51, wherein said flexible penetration-resistant layer is removably coupled to said attachment system.

53. The wearable simulant of claim 52, wherein said flexible penetration-resistant layer is removably coupled to said attachment system by means of a receptacle coupled to said attachment system.

54-133. (canceled)
